(19) United States
(12) Patent Application Publication
(10) Pub. No.: US 2025/0077730 A1
(43) Pub. Date: Mar. 6, 2025

(54) SYSTEMS AND METHODS FOR SIMULATING CHARGER FOR ELECTRIC VEHICLES

(71) Applicant: Toyota Research Institute, Inc., Los Altos, CA (US)

(72) Inventors: Scott Carter, San Jose, CA (US); Emily Sumner, Mountain View, CA (US); Monica PhuongThao Van, Palo Alto, CA (US); Yin-Ying Chen, San Jose, CA (US)

(73) Assignees: Toyota Research Institute, Inc., Los Altos, CA (US); Toyota Jidosha Kabushiki Kaisha, Toyota-shi (JP)

(21) Appl. No.: 18/239,357

(22) Filed: Aug. 29, 2023

(51) Int. Cl. G06F 30/20; G06F 3/01; G06T 11/00

(52) U.S. Cl. CPC G06F 30/20; G06F 3/011; G06T 11/00

(57) ABSTRACT

Methods and systems disclosed are directed to a virtual simulation of chargers in a real-world environment having a wiring system using, a camera, an augmented reality (AR) interface, and a processor operable to generate a virtual charger representing a charger superimposed on the real-world environment, receive data responsive to a user interaction using the AR interface to operate the virtual charger, update the virtual charger superimposed on the real-world environment based on the operation, and wherein the virtual charger includes a connector and a charging cable including a first end and a second end, the first end operable to be connected to the connector, and the second end operable to be connected to the wiring system.

### TECHNICAL FIELD

The present disclosure relates to virtual simulation, and more particularly, to virtual simulation for electrical chargers.

### BACKGROUND

To facilitate the increasing trend of electric vehicle ownership, users may want to make well-informed decisions about purchasing the appropriate charger and installing it at their desired location. During the determination, users may need to consider selections of a charger compatible with their EV model, charging speed based on daily driving habits, and ensuring the electrical capacity of their home or workplace that can accommodate the charger. Accordingly, there is a need for a system to provide a simulated experience of charger selection and installation.

### SUMMARY

In a first aspect, a method includes generating a virtual charger representing a charger superimposed on a real-world environment including a wiring system, receiving data responsive to a user interaction using an augmented reality (AR) interface to operate the virtual charger, updating the virtual charger superimposed on the real-world environment based on the operation, and wherein the virtual charger includes a connector and a charging cable including a first end and a second end, the first end operable to be connected to the connector, and the second end operable to be connected to the wiring system.

In a second aspect, a system includes a camera, an augmented reality (AR) interface, and a processor. The processor is operable to generate a virtual charger representing a charger superimposed on the real-world environment, receive data responsive to a user interaction using the AR interface to operate the virtual charger, update the virtual charger superimposed on the real-world environment based on the operation, and wherein the virtual charger includes a connector and a charging cable including a first end and a second end, the first end operable to be connected to the connector, and the second end operable to be connected to the wiring system.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a virtual charger installation system of the present disclosure, according to one or more embodiments shown and described herein;

FIG. 2 schematically depicts exemplary non-limiting components of the virtual charger installation system of the present disclosure, according to one or more embodiments shown and described herein;

FIG. 3 schematically depicts an augmented reality view of the installed virtual charger in a real-world environment of the present disclosure, according to one or more embodiments shown and described herein;

FIG. 4 schematically depicts an augmented reality view of the installed virtual charger connected to a virtual electric vehicle in the real-world environment of the present disclosure in a desired manner, according to one or more embodiments shown and described herein;

FIG. 5 schematically depicts an augmented mixed reality view of the installed virtual charger connected to a virtual electric vehicle in the real-world environment of the present disclosure in an undesired manner, according to one or more embodiments shown and described herein; and

FIG. 6 illustrates a flow diagram of illustrative steps for the installation and operation of the virtual charger with the virtual electric vehicle (EV) of the present disclosure, according to one or more embodiments shown and described herein.

### DETAILED DESCRIPTION

The present disclosure involves systems and methods for the virtual simulation of chargers and electric vehicles in a real-world environment having a wiring system by incorporating virtual technologies. The disclosed virtual simulation enable users to virtually simulate installation electric chargers and operation of the installed electric chargers and electric vehicles in a desired space, such as a garage or an outdoor space. Notwithstanding the disclosed use of Augmented Reality (AR), the virtual simulation systems and methods may apply to other simulation technologies, such as Mixed Reality (MR), Extended Reality (XR or X-reality), holography (image overlay), and artificial intelligence (AI) in immersive virtual worlds.

The disclosed systems and methods allow users to ensure that the selected charger is compatible with their specific electric vehicle (EV) model before making a purchase. Further, the virtual simulating charger systems may provide a simulated installation that can provide users with insights into the actual installation process of an EV charger at their home or workplace. The chosen location may be convenient for daily access and weather-protected if outdoors. The simulation helps them understand any potential challenges, space requirements, and electrical modifications that might be necessary before committing to a purchase. Further, virtual simulations can allow users to compare multiple charger models side by side and make a more informed decision based on features, performance, and cost. The user may experiment with different charger models and see how they fit into their home's design and where the most convenient and aesthetically pleasing location for the charger would be. This can help avoid regrets after the physical installation is complete. The chosen location may be convenient for daily access and weather-protected if outdoors. Additionally, users can explore smart charging features, check for incentives, and consider scalability for future EV ownership, all while seeking chargers with good warranties and reliable customer support.

The disclosed systems and methods allow users to simulate the use and installation of the EV charger infrastructure with the wiring system of a location such that users can customize the charging solution to optimize performance and avoid undesired electrical issues. The simulation also allows users to determine whether the existing wiring system and its electrical loads are compatible with the charger and can afford the additional load without overloading circuits. Further, the disclosed systems and methods enable users to select chargers compatible with a desired electric vehicle (EV) model before making a purchase. Users can simulate the storage of the vehicle in the real-world environment along with the simulation of the chargers to charge the simulated EV.

Various embodiments of the methods and systems for simulations of the installation and operation of chargers for electric vehicles are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

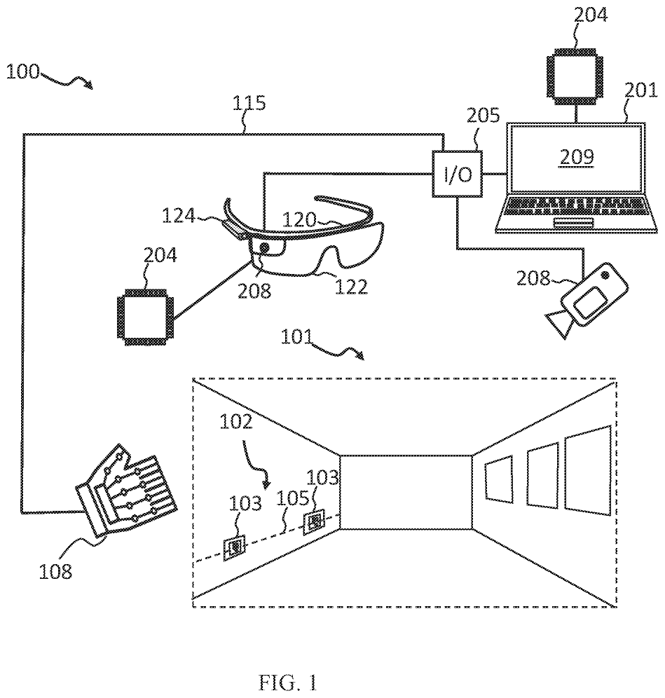

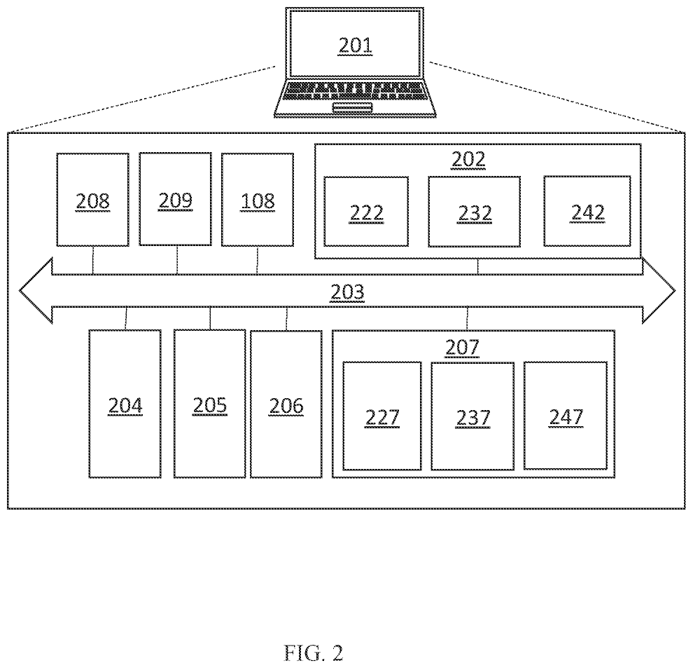

Turning to the figures, FIG. 1 schematically depicts a virtual simulating charger system of the present disclosure. The virtual simulating charger system 100 includes an AR interface 108 operable to interact with the real-world environment 101, a camera 208, a display 209, and a processor 204 (e.g. as illustrated in FIG. 2). The virtual simulating charger system 100 may further include a controller 201 having the display 209, input/output (I/O) hardware 205, and connections 115. The connections 115 connect components of the virtual simulating charger system 100 and allow signal transmission between the components of the virtual simulating charger system 100. For example, the connections 115 may connect the AR interface 108, the camera 208 to the controller 201 at the I/O hardware 205. The connections 115 may be wired or wireless. The virtual simulating charger system 100 may also include a virtual head unit 120 including a camera 208, glasses 122, and a projector 124.

The virtual simulating charger system 100 may include one or more cameras 208. The camera 208 may be operable to acquire image and video data of a real-world environment 101. The real-world environment 101 may include a wiring system 102 including one or more electrical outlets 103, electrical wires 105, and a breaker panel 333. The camera 208 may be, without limitation, a RGB camera, a depth camera, an infrared camera, a wide-angle camera, or a stereoscopic camera. The camera 208 may be equipped, without limitations, on a smartphone, a tablet, a computer, a laptop, or a virtual head unit 120. The virtual simulating charger system 100 may include one or more displays 209. The display 209 may be equipped, without limitations, on a smartphone, a tablet, a computer, a laptop, or a virtual head unit 120, such as augmented reality (AR) glasses.

The virtual simulating charger system 100 may include one or more virtual head units 120. The virtual head unit 120 may include a camera 208, a display 209, glasses 122, a tracking sensor, a processor 204, and a projector 124. The virtual head unit 120 may be used for AR, MR, XR, holography, and AI in immersive virtual worlds and combines VR and AR technologies to provide an immersive and interactive user experience. In embodiments, the virtual head unit 120 may be a see-through display or AR glasses to be worn on the head of a user. The projector 124 may cast virtual images on the glasses or directly onto the user's eyes to be superimposed onto the user's vision such that the virtual images are combined with the real-world view. The tracking sensor, such as, without limitations, an infrared sensor, an accelerometer, a gyroscope, or an external tracking system, may monitor the user's head movements and position. The tracking sensor can use various technologies to track the user's movements.

The virtual simulating charger system 100 includes an augmented reality (AR) interface 108. The AR interface 108 may provide communication between the user and the virtual world. The AR interface 108 may include a tangible object, wherein the tangible object is a marker, a physical model, a sensor, a wearable motion-tracking device, or a smartphone. The AR interface 108 may be, without limitations, a keyboard, a touchpad, a joystick, a voice control module in mobile phones, smart cars, and homes to execute verbal commands, wrist bands that may include electromyographic electrodes that can record hand gestures, devices including electroencephalogram (EEG) electrodes to detect human intentions such as brain wave. For example, a keyboard allows users to input text and commands through physical or virtual keys. A touchpad may include a touch-sensitive surface that allows users to interact with AR applications by tapping, swiping, and performing various gestures. A joystick may include a physical control stick that enables users to manipulate objects or characters within the AR environment, commonly used in gaming applications. A voice control module may allow users to interact with AR devices through spoken commands. Wrist bands may detect and record hand gestures and movements using electromyography (EMG) technology such that the virtual simulating charger system 100 may interact with the users based on the users' intuitive gesture-based interactions. Devices with electroencephalogram (EEG) electrodes may detect brain waves and interpret human intentions and mental states to control virtual objects or devices with their thoughts.

The virtual simulating charger system 100 may include one or more processors. The processor may be included, without limitations, in the controller 201 (such as a computer, a laptop, a tablet, a smartphone, or a medical equipment), the virtual head unit 120, a server, or a third-party electronic device.

Referring to FIG. 2, example non-limiting components of the virtual simulating charger system are depicted. The virtual simulating charger system 100 may include a controller 201. The controller 201 may include various modules. For example, the controller 201 may include a virtual charger module 222, a virtual electric vehicle module 232, and a wiring system module 242. The controller 201 may further comprise various components, such as a memory component 202, a processor 204, an input/output hardware 205, a network interface hardware 206, a data storage component 207, and a local interface 203. The controller 201 may include an AR interface 108, a camera 208, and a display 209.

The controller 201 may be any device or combination of components comprising a processor 204 and a memory component 202, such as a non-transitory computer readable memory. The processor 204 may be any device capable of executing the machine-readable instruction set stored in the non-transitory computer readable memory. Accordingly, the processor 204 may be an electric controller, an integrated circuit, a microchip, a computer, or any other computing device. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. The processor 204 is communicatively coupled to the other components of the controller 201 by the local interface 203. Accordingly, the local interface 203 may communicatively couple any number of processors 204 with one another, and allow the components coupled to the local interface 203 to operate in a distributed computing environment. The local interface 203 may be implemented as a bus or other interface to facilitate communication among the components of the controller 201. In some embodiments, each of the components may operate as a node that may send and/or receive data. While the embodiment depicted in FIG. 2 includes a single processor 204, other embodiments may include more than one processor 204.

The memory component 202 (e.g., a non-transitory computer-readable memory component) may comprise RAM, ROM, flash memories, hard drives, or any non-transitory memory device capable of storing machine-readable instructions such that the machine-readable instructions can be accessed and executed by the processor 204. The machine-readable instruction set may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory component, other embodiments may include more than one memory module. The memory may be used to store the virtual charger module 222, the virtual electric vehicle module 232, and the wiring system module 242. Each of the virtual charger module 222, the virtual electric vehicle module 232, and the wiring system module 242 during operating may be in the form of operating systems, application program modules, and other program modules. Such program modules may include, but are not limited to, routines, subroutines, programs, objects, components, and data structures for performing specific tasks or executing specific abstract data types according to the present disclosure as will be described below.

The input/output hardware 205 may include a monitor, keyboard, mouse, printer, camera, microphone, speaker, and/or other device for receiving, sending, and/or presenting data. The network interface hardware 206 may include any wired or wireless networking hardware, such as a modem, LAN port, Wi-Fi card, WiMax card, mobile communications hardware, and/or other hardware for communicating with other networks and/or devices.

The data storage component 207 stores charger data 227, electric vehicle data 237, and wiring system data 247. The virtual charger module 222, the virtual electric vehicle module 232, and the wiring system module 242 may also be stored in the data storage component 207 during operating or after operation.

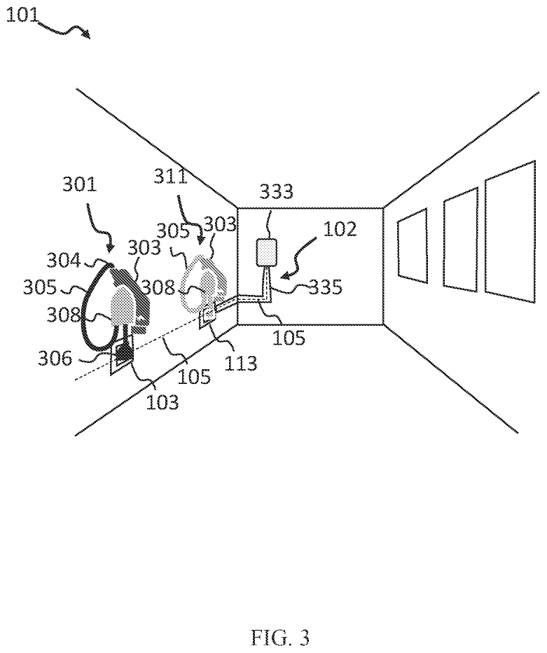

Referring to FIG. 3, an augmented reality view of the installed virtual charger in a real-world environment is depicted. A user who operates the virtual charger installation system 100 in a real-world environment 101 may apply the AR interface 108 to generate a virtual charger 301 representing a charger superimposed on a real-world environment 101 including a wiring system 102. The charger may be selected from the charger data 227 (e.g. as illustrated in FIG. 2), which includes the models of components of the charger 301, meta information such as, without limitations, the models, purchase URLs, descriptive text, compatibility with different EVs, and other desired information for the user to select the charger. The user may select a location for the virtual charger 301 to be installed via the AR interface. The virtual simulating charger system 100 may detect and determine the breaker panel of the real-world environment 101 and the amperage rating of the service to the building. The amperage rating indicates the maximum amount of electrical current that the main service panel can handle. The breaker panel may include individual circuit breakers for each circuit. The virtual simulating charger system 100 may further determine how many free breaker slots are available in the breaker panel, where a breaker slot is a space where an individual circuit breaker can be installed, to determine whether there is enough capacity to accommodate additional circuits or if a sub-panel is needed. The virtual simulating charger system 100 may provide information about how to install the sub-panel or the charger at the selected location, for example how to mount the virtual charger 301 on a wall. The virtual charger installation system 100 then updates the virtual charger 301 superimposed on the real-world environment 101 to the selected location to be installed.

In embodiments, the virtual charger 301 includes a connector 303 and a charging cable 305 including a first end 304 and a second end 306. The virtual charger 301 may include a box or post 308 mounted on the wall of the real-world environment 101. As illustrated in FIG. 3, one part of the charging cable 305 may connect to the electrical outlet 301 and another part of the charging cable 305 connects the box or post 308 to the connecter 303. The first end 304 is operable to be connected to the connector 303, and the second end 304 is operably connected to the wiring system 102. The wiring system 102 may include one or more electrical outlets such as the first electrical outlet 103 and the second electrical outlet 113. The second end 306 of the charging cable 305 may be operably connected to the electrical outlets. The virtual charger 301 may also include a charger hanger. The connector 303 and the charging cable 305 may be removably coupled to the charger hanger. In some embodiments, the virtual charger 301 may be directly hard-wired to the breaker panel 333 with the first end 304 of the charging cable 305 connected to the breaker panel 333. The part of the charging cable 305 connecting the box or post 308 to the breaker panel may be shielded with electric conduit 335.

In embodiments, the controller 201 may provide instructions and steps on the display 209 (e.g. as illustrated in FIG. 1) or cast on the glasses 122 (e.g. as illustrated in FIG. 1) using the projector 124 (e.g. as illustrated in FIG. 1) to operate the AR interface 108 (e.g. as illustrated in FIG. 1) in the real-world environment 101 with a wiring system 102. For example, the controller 201 may provide instructions and steps on the display 209 or the glasses 122 to instruct the user to practice an appropriate position and gestures for the installation and operation of the virtual charger 301. The controller 201 may instruct the user to use the camera 208 to search the environment for available components of the wiring system 102, such as, without limitations, electrical outlets (e.g. a first electrical outlet 103 and a second electrical outlet 113), breaker panel 333, and electric wires 105. Further, the controller 201 may instruct the user to visually identify and locate the relevant wiring system 102 in the real-world environment 101. The controller 201 may instruct the user to follow more steps provided on the display 209 or the glasses 122 to select a location for the virtual charger 301 to be installed. During the process, the camera 208 may monitor the position of the real-world environment 101 and the wiring system 102 and update any simulated models including the virtual chargers 103 to be superimposed in the real-world environment 101 in real-time. The camera 208 may be used to generate a building structure of the real-world environment 101 based on the images acquired in an initial scan.

In embodiments, the virtual charger installation system 100 may include one or more electrical outlets 103 of the wiring system 102 connected with electrical wires 105. For instance, as illustrated in FIG. 3, the wiring system 102 includes a first electrical outlet 103 and a second electrical outlet 113, connected via the electrical wire 105. The wiring system 102 may further include a breaker panel 333. The breaker panel 333 may connect with the first electrical outlet 103 and the second electrical outlet 113 via the electrical wire in an electrical conduit 335.

A user may use the AR interface 108 to select a location for the virtual charger 103 to be installed, such as a position close to the first electrical outlet 103 or the second electrical outlet 113. The virtual simulating charger system 100 may assign an anchor to the selected location and generate the virtual charger 301 at the anchor around the electrical outlet 103 or the virtual charger 311 at the anchor around the electrical outlet 113, superimposed on the real-world environment 101. In some embodiments, when the user uses the AR interface 108 to select a charger location in the real-world environment where no electrical outlet 103 is nearby, the virtual simulating charger system 100 may generate the electrical outlet (e.g. the second electrical outlet 113 when the building includes only the first electrical outlet 103 in the real-world environment 101) and make an arrangement of an electrical conduit 335 routed from the virtual charger 311 generated at the anchor near the generated electrical outlet such as the second electrical outlet 113 to the breaker panel 333. In some embodiments, the virtual simulating charger system 100 may generate an electrical conduit 335 directly connecting the virtual charger 301 to the breaker panel without the electrical outlet 103. The electric conduit may be a surface-mount conduit, a concealed conduit, or a combination of a surface-mount conduit and a concealed conduit. The virtual simulating charger system 100 may then superimpose the electrical conduit 333 in the real-world environment 101 to be displayed on the display 209 (e.g. as illustrated in FIG. 1) or the glasses 122 (e.g. as illustrated in FIG. 1).

The virtual simulating charger system 100 may generate the virtual electrical conduit considering factors such as, without limitations, the accessibility, distance from the breaker panel, potential obstacles or obstructions, conduit installation requirements, wire type, safety standard, the voltage of the charger, the material of the conduit (such as polyvinyl chloride (PVC), electrical metallic tubing (EMT), cost of the installation, and other factors for consideration during an electrical conduit installation. The generated electrical conduit 335 may include a surface-mount conduit, a concealed conduit, or a combination of a surface-mount conduit, and a concealed conduit. The generated electric conduit 335 may be a short and direct path from the breaker panel 333 to the desired installation position of the charger. The generated electric conduit 335 may minimize bends and turns in the electrical conduit 335.

The initially generated virtual chargers may be, as illustrated in FIG. 3, in a resting position, where the connector 303 of the virtual charger 301 is not connected to an EV. A user may use the AR interface 108 to operate the generated virtual charger 301. For example, the user may conduct operations, such as, without limitations, a disconnection of the virtual charger 301 from the first electrical outlet 103, followed by a connection of the virtual charger 311 to the second electrical outlet 113, an assembly of the virtual charger 301 from components including the connector 303, the charging cable 305, the hanger, a disassembly of the virtual charger, a connection of the virtual charger to the wiring system, or a disconnection of the virtual charger from the wiring system.

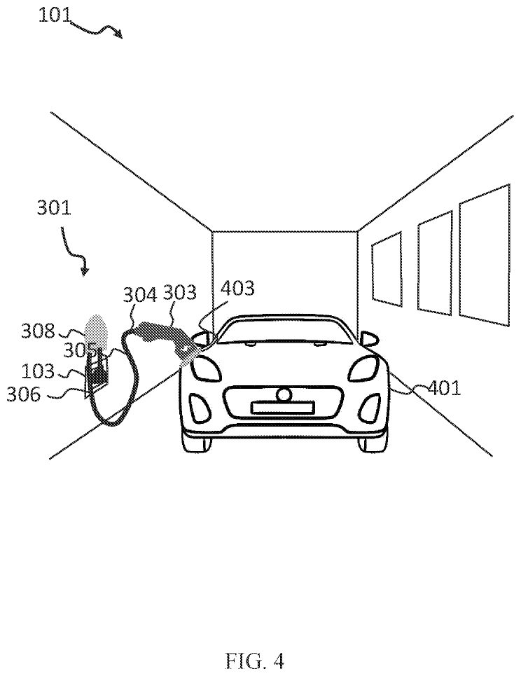

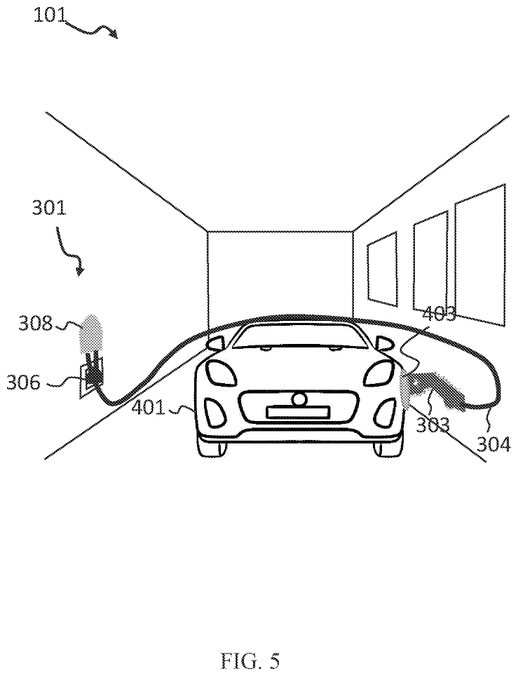

Referring to FIGS. 4 and 5, augmented reality views of the installed virtual charger connected to a virtual electric vehicle in the real-world environment are depicted. The user may use the AR interface 108 (e.g. as illustrated in FIG. 1) to further select an electric vehicle (EV) from the EV data 237 (e.g. as illustrated in FIG. 2) and select a position to generate, using the virtual electric vehicle module 232 (e.g. as illustrated in FIG. 2), a virtual EV displayed in the display 209 or the glasses 122 and superimposed on the real-world environment 101. The user may use the AR interface 108 to change the orientation of the virtual EV 401 and move the virtual EV 401 in real-time. The virtual electric vehicle 401 includes a charging port 403 operable to connect to the connector 303 of the virtual charger 301 when in the mode of charging. The virtual simulating charger system 100 may determine whether the selected EV model is compatible with the selected charger. Upon determination of incompatibility between the EV model and charger, the virtual simulating charger system may warn the user and instruct the user to change the selection of the charger and/or the EV model. The virtual simulating charger system 100 may also determine whether the selected EV may be placed in the real-world environment 101, considering the size and/or shape of the EV. Upon determination of incompatibility between the EV model and the real-world environment 101, the virtual simulating charger system may warn the user and instruct the user to change the selection of the EV model.

The user may perform operations or practices over the virtual charger 301 and/or the virtual EV 401. The operations or practices may be performed locally or remotely. Images and videos of the operation of the virtual charger 301 and/or the virtual EV 401 may be captured by one or more cameras 208 (e.g. as illustrated in FIGS. 1 and 2). The generated AR image or video may be displayed at the display 209 or virtual head unit 120. In some embodiments, a server or a third-party controller may generate the AR image or video asynchronously or synchronously and further transmit the generated AR image or video to a remote controller for display at a remote location.

The user may use the AR interface 108 to operate the virtual charger 301 and the virtual EV 401 for connecting the connector 303 of the virtual charger 301 to the charging port 403 of the virtual EV 401. The virtual simulating charger system 100 may generate an arrangement of the charging cable 305 connecting to the connector 303 at the first end 304 and connecting to the wiring system 102 at the second end 305. The virtual simulating charger system 100 may consider various factors in generating the arrangement of the charging cable, such as, without limitations, the cable length, space interruption, convenience and ease of use, cost and budget, possibility of cable tangling, and other factors involving cable arrangement in the real-world environment 101.

For example, as illustrated in FIG. 4, the virtual EV 401 includes the charging port 403 on the same side as the installed virtual charger 301. The connection of cable 305 between the connector 303 and the electrical outlet 103 is short and the virtual charger 301 is easy to use by the user to move between a resting position (e.g. as illustrated in FIG. 3) and the charging position (e.g. as illustrated in FIG. 4), from the charger box or post 308 to the charging port 403, and vice versa. The short cable arrangement allows the user to move the virtual charger to where it is needed without much effort. The short cable arrangement may reduce the chance of tripping or tangling, and contributes to a safer charging environment, reducing the risk of accidents or cable damage. It may further leave a channel on the other side the virtual EV and people can move freely without any interruptions caused by the charging setup. This design ensures that the charging arrangement does not obstruct the movement of users or create any inconvenience in the space.

Conversely, as illustrated in FIG. 5, the virtual EV 401 includes the charging port 403 on the opposite side to the installed virtual charger 301. The connection of cable 305 between the connector 303 and the electrical outlet 103 is over the roof and the user may find it inconvenient to use the virtual charger 301 when the user moves the connector 303 from the charger box or post 308 to the charging port 403, or vice versa. The long cable arrangement may increase the chance of tripping or tangling, and contributes to a less desirable charging environment, increasing the risk of accidents or cable damage. It may block the channels on both sides the virtual EV and people may pass with the interruptions caused by the charging setup. This design may not ensure that the charging arrangement does not obstruct the movement of users or create any inconvenience in the space. In such cases, the virtual simulating charger system 100 may instruct the user with different solutions, such as, without limitations, alternating charging points by locating the charging point closer to the virtual EV 401, using cable management solutions to secure the cable safely and neatly alongside the vehicle or on the ground to prevent tangling and tripping hazards, and implementing overhead charging cable arrangements that are strategically positioned to avoid running the cable over the vehicle or block the channels that people moves through.

The virtual simulating charger system 100 may generate a parts list of the selected charger as represented as the virtual charger 301, the components required to modify the wiring system 102 to accommodate the usage of the selected charger in the real-world environment 101. The user then can make informed decisions about whether the selected charger is suitable for the wiring system 102 and receive further recommendations for the modifications of the wiring system 102. The parts list and components may include, without limitations, an adapter or converter, special wiring and connectors, circuit breakers or fuses, specific types of outlet or socket, mounting hardware, grounding components, additional cabling and conduits, voltage regulator or stabilizer, installation materials, and safety labels.

The virtual simulating charger system 100 may generate electrical drawings that can be used for requesting an electrical permit/building permit with the proper authority. The electrical drawings may illustrate the proposed electrical changes, including the addition of the charger and any associated wiring modifications. The electrical drawings may be submitted to the appropriate authorities for requesting an electrical permit or building permit for the installation of the selected charger. The electrical drawings may include information such as, without limitations, charger location, wiring diagrams, circuit details, safety features, voltage and power specifications, and mounting and support.

The virtual simulating charger system 100 may further generate a price quote for the charger system including the selected charger and components required to modify the wiring system 102. The user may use the AR interface 108 (e.g. as illustrated in FIG. 1) or a user interface associated with the controller 201 (e.g. as illustrated in FIG. 1) to select different charger systems. When the user selects a different charger, the quotes and simulated visualizations of the virtual charger 301, the virtual EV 401, and the modification of the wiring system 102 can update based on the selected virtual charger 301.

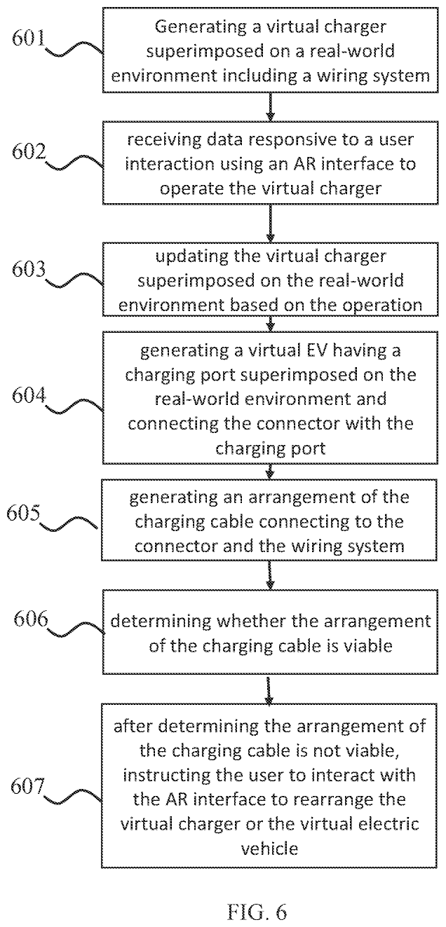

FIG. 6 illustrates a flow diagram of illustrative steps for the installation and operation of the virtual charger with the virtual electric vehicle (EV). At block 601, the method for installation and operation of the virtual charger includes generating, using the virtual charger module 222 (e.g. as illustrated in FIG. 2), a virtual charger representing a charger superimposed on a real-world environment having a wiring system. The virtual charger includes a connector and a charging cable including a first end and a second end, the first end operable to be connected to the connector, and the second end operable to be connected to the wiring system. The virtual charger may further include a charger hanger, wherein the connector and the charging cable are operable to removably coupled to the charger hanger. The wiring system may include, without limitations, a first electrical outlet and a second electrical outlet. The wiring system may further include an electrical outlet, wherein the second end of the charging cable is connected to the electrical outlet. The method further may include providing information about the virtual charger such as, without limitations, maintenance operations.

At block 602, the method for installation and operation of the virtual charger includes receiving data responsive to the user interaction using the AR interface to operate the virtual charger. The operation is, without limitations, an assembly of the virtual charger, a disassembly of the virtual charger, a connection of the virtual charger to the wiring system, or a disconnection of the virtual charger from the wiring system. The operation may be a disconnection of the virtual charger from the first electrical outlet and a connection of the virtual charger to the second electrical outlet.

At block 603, the method for installation and operation of the virtual charger includes updating the virtual charger superimposed on the real-world environment based on the operation.

The method for installation and operation of the virtual charger may further include determining, using the virtual charger module 222 (e.g. as illustrated in FIG. 2) and the wiring system module 242 (e.g. as illustrated in FIG. 2), whether the charger is compatible with the wiring system, and after determining the charger is not compatible with the wiring system, providing an option for a different charger or a modification plan of the wiring system, which may be selected from the charge data 227 and/or the wiring system data 247 (e.g. as illustrated in FIG. 2).

The modification plan of the wiring system may include installing an electrical outlet having a higher volt value than the volt value of the wiring system 102, e.g. from 110 V to 220 V, from 120 V to 240 V. The modification plan of the wiring system may include potential impacts to the user's building, e.g. wires that would need to be run or components that would need to be modified on the breaker panel. The modification plan of the wiring system may further include adjustment to the walls and doors of the building in the real-world environment when the charger may be installed out-of-door, such as in driveways. The method may further include generating dynamic objects superimposed in the real-world environment. For example, how a person or animal may walk through the scene, whether a child may be able to reach and interact with the charging apparatus, and how the charger may be operated in an emergency scenario such as a fire, earthquake, or flood.

The method may further include providing purchase information of the charger, such as, without limitations, the price, place to purchase, available website and/or link for purchase, and any purchase information of the charger.

The method for installation and operation of the virtual charger may further include receiving data responsive to the user interaction using the AR interface to select a charger location in the real-world environment including a breaker panel, generating an arrangement of an electrical conduit routed from the virtual charger to the breaker panel, the electric conduit comprising a selection from a surface-mount conduit, a concealed conduit, and a combination thereof, and superimposing the electrical conduit in the real-world environment.

At block 604, the method for installation and operation of the virtual charger further includes generating, using the virtual electric vehicle module 232 (e.g. as illustrated in FIG. 2), a virtual electric vehicle superimposed on the real-world environment, wherein the virtual electric vehicle comprises a charging port and connecting the connector with the charging port. At block 605, the method for installation and operation of the virtual charger includes generating an arrangement of the charging cable connecting to the connector at the first end and connecting to the wiring system at the second end. At block 606, the method for installation and operation of the virtual charger includes determining whether the arrangement of the charging cable is viable such that the charging cable connects the connector and the wiring system without across an obstacle or a restricted area in the real-world environment. At block 607, the method for installation and operation of the virtual charger includes, after determining the arrangement of the charging cable is not viable, instructing the user to interact with the AR interface to rearrange the virtual charger or the virtual electric vehicle. In some embodiments, the method includes, after determining the arrangement of the charging cable is not viable, recommending a placement for the virtual charger or the virtual electric vehicle to allow the arrangement of the charging cable in a manner that avoids crossing an obstacle or a restricted area in the real-world environment. In some embodiments, the method may suggest a location for the virtual charger or the virtual electric vehicle if it is not feasible to position the charging cable.

The method for installation and operation of the virtual charger may include generating a parts list of the selected charger and the modification plan of the wiring system. The method may also include generating a price quote for the selected charger and components required for the modification of the wiring system.

When arranging charger cables, it is not desirable to have the charging cable cross over certain areas, such as having obstacles or a restricted area, due to safety and convenience considerations. The restricted area may include, without limitations, walkways and pathways, doorways and entrances, emergency exits and fire safety equipment, staircases and steps, high-traffic areas (such as busy corridors, common gathering spaces, and areas near shared facilities like kitchens or break rooms), and hazardous areas (such as areas with hot surfaces, exposed electrical equipment, or flammable materials).

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including matters of logic with respect to the arrangement of steps, operational flow, order of components, or orientation of components; plain meaning derived from grammatical organization or punctuation, and; the number or type of embodiments described in the specification.

While particular embodiments have been illustrated and described herein, it may be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A method comprising:
generating a virtual charger representing a charger superimposed on a real-world environment comprising a wiring system;
receiving data responsive to a user interaction using an augmented reality (AR) interface to operate the virtual charger;
updating the virtual charger superimposed on the real-world environment based on the operation; and
wherein the virtual charger comprises a connector and a charging cable comprising a first end and a second end, the first end operable to be connected to the connector, and the second end operable to be connected to the wiring system.

2. The method of claim 1, wherein the operation is an assembly of the virtual charger, a disassembly of the virtual charger, a connection of the virtual charger to the wiring system, or a disconnection of the virtual charger from the wiring system.

3. The method of claim 1, wherein the wiring system comprises a first electrical outlet and a second electrical outlet, the operation is a disconnection of the virtual charger from the first electrical outlet and a connection of the virtual charger to the second electrical outlet.

4. The method of claim 1, wherein the wiring system comprises an electrical outlet, wherein the second end of the charging cable is connected to the electrical outlet.

5. The method of claim 1, wherein the virtual charger further comprises a charger hanger, wherein the connector and the charging cable are operable to removably coupled to the charger hanger.

6. The method of claim 1, wiring system comprising a breaker panel, wherein the method further comprises:
receiving data responsive to the user interaction using the AR interface to select a charger location in the real-world environment;
generating an arrangement of an electrical conduit routed from the virtual charger to the breaker panel, the electric conduit comprising a selection from a surface-mount conduit, a concealed conduit, and a combination thereof; and
superimposing the electrical conduit in the real-world environment.

7. The method of claim 1, wherein the method further comprises:
determining whether the charger is compatible with the wiring system;
after determining the charger is not compatible with the wiring system, providing an option for a different charger or a modification plan of the wiring system; and
wherein the modification plan of the wiring system comprises installing an electric outlet having a higher volt value than a volt value of the wiring system.

8. The method of claim 7, wherein the method further comprises generating a parts list of the modification plan of the wiring system and a price quote for the charger and the parts list of the modification plan.

9. The method of claim 1, wherein the method further comprises generating a virtual electric vehicle superimposed on the real-world environment, wherein the virtual electric vehicle comprises a charging port.

10. The method of claim 9, wherein the method further comprises:
connecting the connector with the charging port;
generating an arrangement of the charging cable connecting to the connector at the first end and connecting to the wiring system at the second end;
determining whether the arrangement of the charging cable is viable such that the charging cable connects the connector and the wiring system without across an obstacle or a restricted area in the real-world environment; and
after determining the arrangement of the charging cable is not viable, instructing the user to interact with the AR interface to rearrange the virtual charger or the virtual electric vehicle.

11. The method of claim 1, wherein the AR interface comprises a tangible object, wherein the tangible object is a marker, a physical model, a sensor, a wearable motion-tracking device, or a smartphone.

12. A system comprising a camera, an augmented reality (AR) interface, and a processor operable to:
generate a virtual charger representing a charger superimposed on a real-world environment comprising a wiring system;
receive data responsive to a user interaction using the AR interface to operate the virtual charger;
update the virtual charger superimposed on the real-world environment based on the operation; and
wherein the virtual charger comprises a connector and a charging cable comprising a first end and a second end, the first end operable to be connected to the connector, and the second end operable to be connected to the wiring system.

13. The virtual simulating charger system of claim 12, wherein the operation is an assembly of the virtual charger, a disassembly of the virtual charger, a connection of the virtual charger to the wiring system, or a disconnection of the virtual charger from the wiring system.

14. The virtual simulating charger system of claim 12, wherein the wiring system comprises a first electrical outlet and a second electrical outlet, the operation is a disconnection of the virtual charger from the first electrical outlet and a connection of the virtual charger to the second electrical outlet.

15. The virtual simulating charger system of claim 12, wherein the wiring system comprises an electrical outlet, wherein the second end of the charging cable is connected to the electrical outlet.

16. The virtual simulating charger system of claim 12, wherein the virtual charger further comprises a charger hanger, wherein the connector and the charging cable are operable to removably coupled to the charger hanger.

17. The virtual simulating charger system of claim 12, wiring system comprising a breaker panel, wherein the processor is operable to further:
receive data responsive to the user interaction using the AR interface to select a charger location in the real-world environment;
generate an arrangement of an electrical conduit routed from the virtual charger to the breaker panel, the electric conduit comprising a selection from a surface-mount conduit, a concealed conduit, and a combination thereof; and
superimpose the electrical conduit in the real-world environment.

18. The virtual simulating charger system of claim 12, wherein the processor is operable to further:
determine whether the charger is compatible with the wiring system;
after determining the charger is not compatible with the wiring system, provide an option for a different charger or a modification plan of the wiring system; and
wherein the modification plan of the wiring system comprises installing an electrical outlet having a higher volt value than a volt value of the wiring system.

19. The virtual simulating charger system of claim 12, wherein the processor is operable to further:
generate a virtual electric vehicle superimposed on the real-world environment, wherein the virtual electric vehicle comprises a charging port;
connect the connector with the charging port;
generate an arrangement of the charging cable connecting to the connector at the first end and connecting to the wiring system at the second end;
determine whether the arrangement of the charging cable is viable such that the charging cable connects the connector and the wiring system without across an obstacle or a restricted area in the real-world environment; and
after determining the arrangement of the charging cable is not viable, instruct the user to interact with the AR interface to rearrange the virtual charger or the virtual electric vehicle.

20. The virtual simulating charger system of claim 12, wherein the AR interface comprises a tangible object, wherein the tangible object is a marker, a physical model, a sensor, a wearable motion-tracking device, or a smartphone.
